(19) United States
(12) Patent Application Publication
(10) Pub. No.: US 2026/0075373 A1
(43) Pub. Date: Mar. 12, 2026

(54) BEHIND-THE-EAR HEARING AID

(71) Applicant: OXTI Pte Ltd, Singapore (SG)

(72) Inventor: Chih-Feng Ho, Singapore (SG)

(21) Appl. No.: 18/830,610

(22) Filed: Sep. 11, 2024

(51) Int. Cl. H04R 25/00; H04R 1/10

(52) U.S. Cl. CPC H04R 25/607; H04R 1/1025; H04R 25/554; H04R 2225/0213

(57) ABSTRACT

A behind-the-ear hearing aid includes a right ear hearing aid and a left ear hearing aid, each of which includes a hanging rod and a battery module. The hanging rod has an arc-shaped structure, and a top of the battery module is provided with an output port. The bottom of the hanging rod has a first guiding rod that is inserted into the output port. Arranged inside the hanging rod are a main control circuit board and a sound adjustment button. The arc-shaped structure of the hanging rod facilitates hanging of the right and left ear hearing aids on the ears of a user, with the sound tube being inserted into the ear auricle of the user. The arc-shaped structure of the hanging rod increases the stability of the hearing aids on the ears, preventing them from falling out easily.

### BACKGROUND OF THE INVENTION

### (a) Technical Field of the Invention

The present invention relates to the field of hearing aid devices, and more particularly to a behind-the-ear hearing aid.

### (b) Description of the Prior Art

A hearing aid refers to any tool, device, apparatus, or instrument that helps individuals with hearing impairments improve their auditory abilities and enhance their communication skills with others. Hearing aids can be categorized based on their external structure into: box-type, behind-the-ear, and in-ear type. The in-ear type is further divided into standard in-ear, canal-type, and deep canal-type. Patients choose the most suitable hearing aid based on their individual conditions.

Existing behind-the-ear hearing aids typically have an earplug connected directly to a main unit via a wire. During use, the earplug is inserted into the ear canal of the wearer, and the main unit is positioned behind the ear, hanging on the ear via the wire. In this type of hearing aid, the wire is relatively thin and soft and cannot effectively restrict the earplug, leading to frequent dislodging of the earplug.

### SUMMARY OF THE INVENTION

To address the shortcomings of existing technology, the present invention provides a behind-the-ear hearing aid that is convenient to wear.

To achieve the above objective, the present invention provides the following technical solution. A behind-the-ear hearing aid comprises a right ear hearing aid and a left ear hearing aid, each of which comprises a hanging rod and a battery module. The hanging rod has an arc-shaped structure, and a top of the battery module is provided with an output port. A bottom of the hanging rod is provided with a first guiding rod that is insertable into the output port. Arranged inside the hanging rod are a main control circuit board and a microphone. A sound adjustment button is arranged, in an embedded manner, in an outer side of the hanging rod. The main control circuit board comprises a potentiometer, an amplifier, and a receiver. The sound adjustment button is electrically connected to the microphone. An end of the hanging rod is equipped with a sound tube. A charging port is provided on a bottom of the battery module. The sound tube houses a microphone that is electrically connected to the receiver. The receiver is electrically connected to the amplifier, and the amplifier is electrically connected to the potentiometer, and the potentiometer is electrically connected to the microphone.

To facilitate carrying, the present invention includes a charging box. A charging box cover is hinged to a top of the charging box. The charging box defines a storage slot, and a control circuit board and a battery are arranged inside the charging box, with the battery electrically connected to the control circuit board. The control circuit board has an electromagnetic switch. The storage slot includes a placement slot and a charging slot. A bottom of the charging slot is provided with a second guiding rod, and the hanging rod is placeable in the placement slot and the battery module is placeable in the charging slot. The second guiding rod is insertable into the charging port. The electromagnetic switch is connected to the battery via a wire. The charging box has a power switch, which is connected to a control end of the electromagnetic switch. The charging box also has a power port, which is electrically connected to the battery.

To enhance the comfort of the sound tube, the present invention comprises a rubber sleeve covering an outer side of the sound tube.

To improve the performance, the present invention comprises a wireless communication unit arranged on the main control circuit board, such as a Bluetooth unit.

To improve the effectiveness of the charging box, the present invention comprises a display screen arranged on the charging box. The control circuit board includes a processor and indicator lights. The power port, the display screen, and the indicator lights are connected to the processor via wires.

Compared to existing technology, the present invention provides a behind-the-ear hearing aid that has the following beneficial effects:

The present invention alleviates the drawbacks of the existing technology by using an arc-shaped hanging rod, which makes it easier to hang the right and left ear hearing aids on the ears of the wearer. The sound tube is inserted into the ear auricle, and the arc-shaped hanging rod enhances the stability of the hearing aids on the ears, preventing them from falling out easily.

### BRIEF DESCRIPTION OF THE DRAWINGS

FIG. 1 is a schematic view showing a structure of the present invention;

FIG. 2 is a schematic rear view showing a charging box according to the present invention;

FIG. 3 is a schematic top view showing the charging box according to the present invention;

FIG. 4 is a cross-sectional view showing the charging box according to the present invention; and

FIG. 5 is a schematic view showing a main control circuit board according to the present invention.

### DETAILED DESCRIPTION OF THE PREFERRED EMBODIMENTS

In the following, the technical solutions of the present invention will be described clearly and completely with reference to the accompanying drawings and embodiments. It is evident that the described embodiments are only a part of the embodiments of the present invention, not all of them. All other embodiments contemplated by those skilled in the art without creative efforts are within the scope of protection of the present invention.

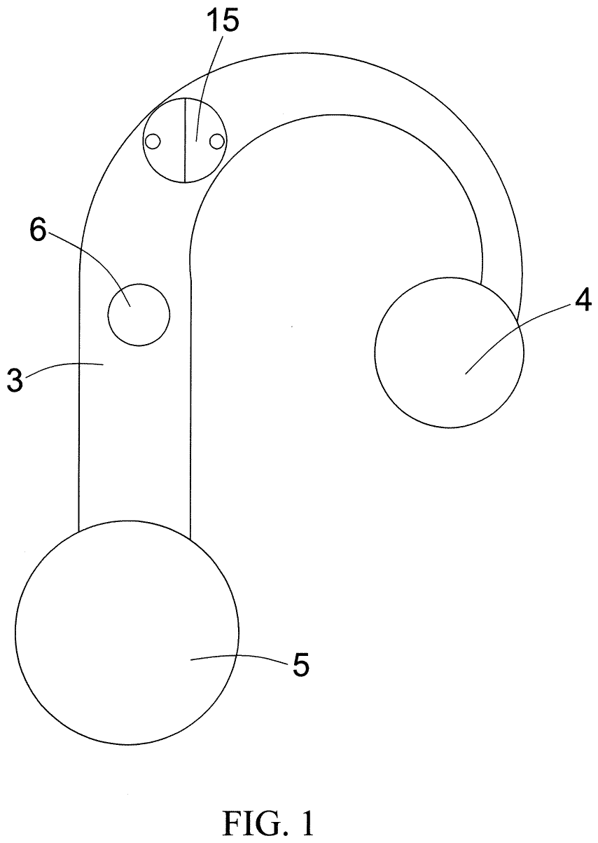

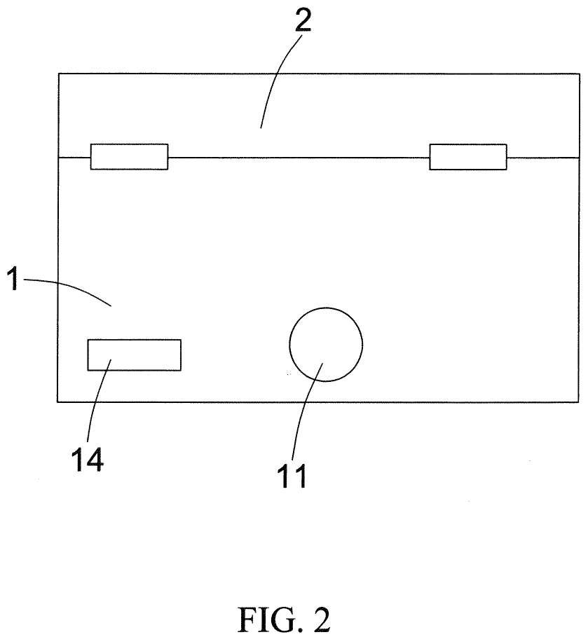

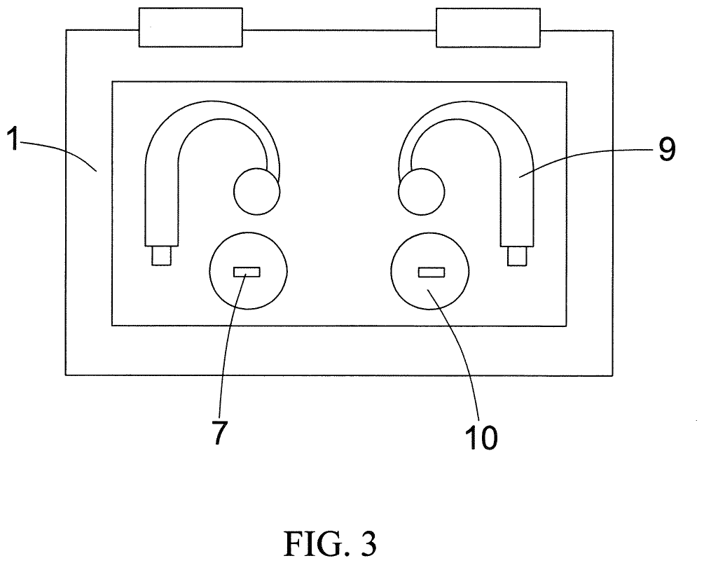

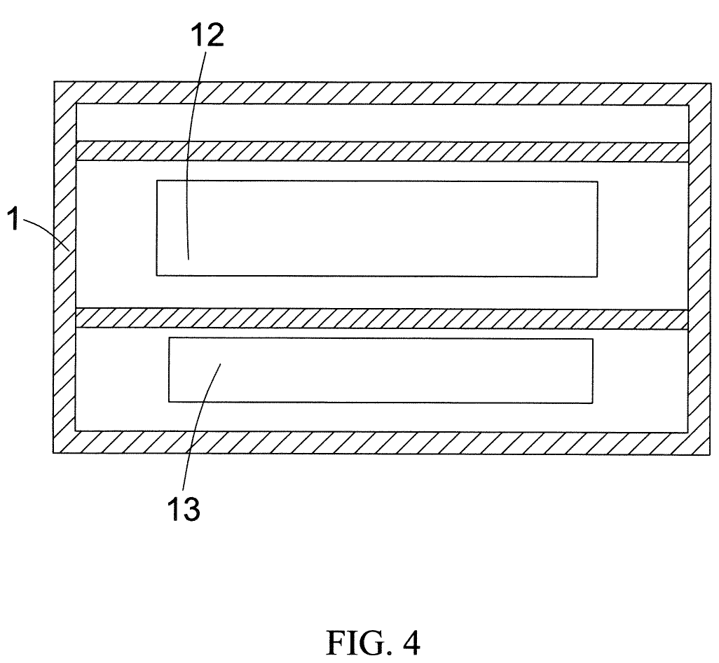

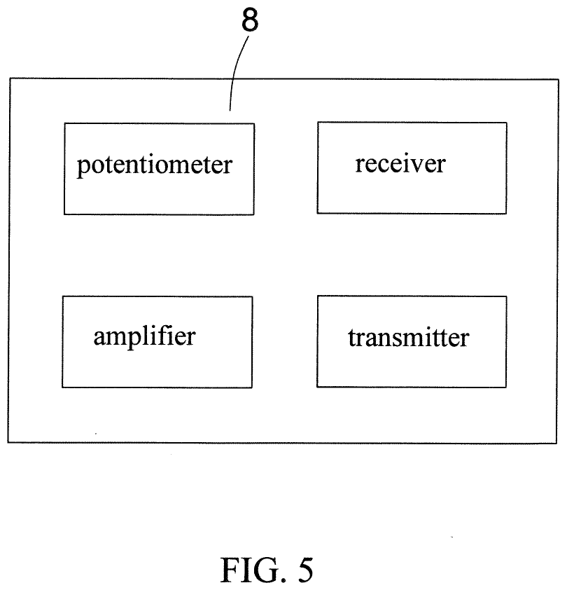

Referring to FIGS. 1-5, the present invention provides a behind-the-ear hearing aid, comprising a right ear hearing aid and a left ear hearing aid, which comprise a hanging rod (3) and a battery module (5). The hanging rod (3) has an arc-shaped structure. A top of the battery module (5) is provided with an output port. A bottom of the hanging rod (3) is provided with a first guiding rod, which is inserted into the output port. Arranged inside the hanging rod (3) are a main control circuit board (8) and a microphone (6). A sound adjustment button (15) is arranged, in an embedded manner, in an outer side of the hanging rod (3). The main control circuit board (8) comprises a potentiometer, an amplifier, and a receiver. The sound adjustment button (15) is electrically connected to the microphone. An end of the hanging rod (3) is equipped with a sound tube (4). A charging port is provided on a bottom of the battery module (5). The sound tube (4) houses a microphone, which is electrically connected to the receiver. The receiver is electrically connected to the amplifier, and the amplifier is connected to the potentiometer, and the potentiometer is connected to the microphone (6).

Without a storage device, the right and left ear hearing aids are inconvenient to carry and charge when going out. In the embodiment, a charging box (1) is provided. A charging box cover (2) is hinged to a top of the charging box (1). Arranged inside the charging box (1) are a storage slot, a control circuit board (12), and a battery (13). The battery (13) is electrically connected to the control circuit board (12). The control circuit board (12) has an electromagnetic switch. The storage slot includes a placement slot (9) and a charging slot (10). A bottom of the charging slot (10) is provided with a second guiding rod (7). The hanging rod (3) is receivable and thus placed in the placement slot (9), and the battery module (5) is receivable and thus placed in the charging slot (10). The second guiding rod (7) is insertable into the charging port of the battery module (5). The electromagnetic switch is connected to the battery (13) via a wire. The charging box (1) has a power switch (11) connected to a control end of the electromagnetic switch. The charging box (1) also has a power port (14) connected to the battery (13). This setup facilitates separation and placement of the battery module (5) and the hanging rod (3) from/into the storage and charging slots of the charging box (1) for portability. When the battery module (5) is placed in the charging slot (10), the charging port electrically connects with the second guiding rod (7) to charge. The battery (13) in the charging box (1) can be charged from an external power supply through the power port (14). The structures of the battery (13), the electromagnetic switch, and the power switch (11) are not specifically limited and can be known components used in headphone charging boxes.

The sound tube (4) may easily cause friction with an ear auricle of a user when inserted therein, potentially leading to discomfort or injury. To prevent this, an outer side of the sound tube (4) is covered with a rubber sleeve to provide cushioning, improving the comfort of the sound tube (4) against the ear auricle. The rubber sleeve is a known structure used in headphone devices.

To facilitate external device connections, such as computers or phones for music playback or other functions, the main control circuit board (8) is equipped with a wireless communication unit, which is preferably a Bluetooth unit. This allows for remote adjustment of the sound volume of the right and left ear hearing aids. The wireless communication unit can be a known Bluetooth unit used in headphone devices.

To monitor the battery power level of the charging box (1) and the right and left ear hearing aids, the charging box (1) is equipped with a display screen. The control circuit board (12) includes a processor and indicator lights. The power port (14), the display screen, and the indicator lights are connected to the processor via wires. This setup allows the display screen to show the charging status and battery power level of the battery module (5). During charging, the processor controls the indicator lights to provide prompts. The processor can be a known microcontroller.

In summary, the behind-the-ear hearing aid of the present invention, by using an arc-shaped hanging rod (3), makes it easy to hang the right and left ear hearing aids on the ears of the user with the sound tube (4) into the ear auricle. The arc-shaped hanging rod (3) increases the stability of the hearing aids, preventing them from falling out as prior art in-ear hearing aids might happen. The hearing aid converts sound signals into electrical signals via the microphone (6) and the potentiometer, amplifies them through the amplifier, and transforms them back into sound signals through the receiver. The sound is then transmitted into the ear through the sound tube (4), which can be fitted against the ear auricle or ear canal. The sound adjustment button (15) allows adjustment of the sound volume. The battery module (5) is connected to the hanging rod (3) via the first guiding rod for detachable connection. When the battery module (5) becomes low in power level, it can be removed and placed into the charging slot (10) for recharging by connecting the charging port with the second guiding rod (7). The charging box (1) makes it convenient to carry the separated battery module (5) and casing. The structures of the microphone (6), the potentiometer, the amplifier, receiver, and the sound tube (4) can be known components from hearing aid devices, and the connection between the charging port and the first guiding rod can be a standard power connection structure.

Although the embodiments of the present invention have been shown and described, those skilled in the art will understand that various modifications, changes, substitutions, and alterations can be made without departing from the principles and spirit of the present invention. The scope of the present invention is defined by the appended claims and their equivalents.

I claim:

1. A behind-the-ear hearing aid, comprising a right ear hearing aid and a left ear hearing aid, each of which comprises a hanging rod and a battery module, the hanging rod having an arc-shaped structure, a top of the battery module having an output port, a bottom of the hanging rod being provided with a first guiding rod, which inserts into the output port, a main control circuit board and a microphone being arranged inside the hanging rod, a sound adjustment button being arranged, in an embedded manner, in an outer side of the hanging rod, the main control circuit board comprising a potentiometer, an amplifier, and a receiver, the sound adjustment button being electrically connected to the microphone. an end of the hanging rod being equipped with a sound tube, a charging port being provided on a bottom of the battery module, the sound tube having a microphone installed inside and electrically connected to the receiver, the receiver being electrically connected to the amplifier, the amplifier being electrically connected to the potentiometer, the potentiometer being electrically connected to the microphone.

2. The behind-the-ear hearing aid according to claim 1, further comprising a charging box, a charging box cover being hinged to a top of the charging box, the charging box defining therein a storage slot and being equipped with a control circuit board and a battery, the battery being electrically connected to the control circuit board, the control circuit board having an electromagnetic switch, the storage slot including a placement slot and a charging slot, a bottom of the charging slot being provided with a second guiding rod, the hanging rod being placeable in the placement slot, the battery module being placeable in the charging slot, the second guiding rod being insertable into the charging port, the electromagnetic switch being connected to the battery via a wire, the charging box having a power switch, which is connected to a control end of the electromagnetic switch, the charging box having a power port, which is electrically connected to the battery.

3. The behind-the-ear hearing aid according to claim 2, wherein the sound tube is covered with a rubber sleeve on an outside thereof.

4. The behind-the-ear hearing aid according to claim 3, wherein the main control circuit board comprises a wireless communication unit, which is a Bluetooth unit.

5. The behind-the-ear hearing aid according to claim 4, wherein the charging box comprises a display screen, and the control circuit board comprises a processor and an indicator light, the power port, the display screen, and the indicator light being connected to the processor via wires.
